(19) United States
(12) Patent Application Publication
(10) Pub. No.: US 2021/0397795 A1
(43) Pub. Date: Dec. 23, 2021

(54) System for Processing Continuous Feedback

(71) Applicant: Michael Gregory Alcock, Kirkland, WA (US)

(72) Inventor: Michael Gregory Alcock, Kirkland, WA (US)

(21) Appl. No.: 16/903,632

(22) Filed: Jun. 17, 2020

(51) Int. Cl. G06F 40/35; G06Q 50/00; H04L 29/06; G06N 20/00

(52) U.S. Cl. CPC G06F 40/35; G06Q 50/01; G06Q 30/0216; G06N 20/00; H04L 63/14; H04L 63/0421

(57) ABSTRACT

A system and methods of processing feedback for use by a large organization which process the information using artificial intelligence and graphically display the results is disclosed. The continuous process of refining the data of this method and system uses collective reactions to correct misinterpreted feedback to improve the quality and accuracy of future iterations.

### TECHNICAL FIELD

The present invention relates to a method of compiling and processing information received from a feedback inquiry using artificial intelligence.

### BACKGROUND

Schools, companies, governments, and other organizations all benefit from feedback collected from employees, users, customers, and citizens. Occasionally, feedback may not be truthfully relayed, truthfully transmitted, or accurately interpreted. Feedback sources may be reluctant to offer accurate information. Several layers which may intentionally or unintentionally distort results may exist between feedback sources and destinations. Feedback processed by humans may be slow and expensive. The present invention alleviates these issues using a computer system.

### SUMMARY OF THE INVENTION

The present application discloses a system and methods of processing feedback for use by a large organization which anonymize the sources, process the information using artificial intelligence, and graphically display the results. The continuous process of refining the data of this method and system uses collective reactions to any misinterpreted feedback to improve the quality and accuracy of future iterations.

### BRIEF DESCRIPTION OF DRAWINGS

FIG. 1 shows a flowchart of the System for Processing Continuous Feedback.

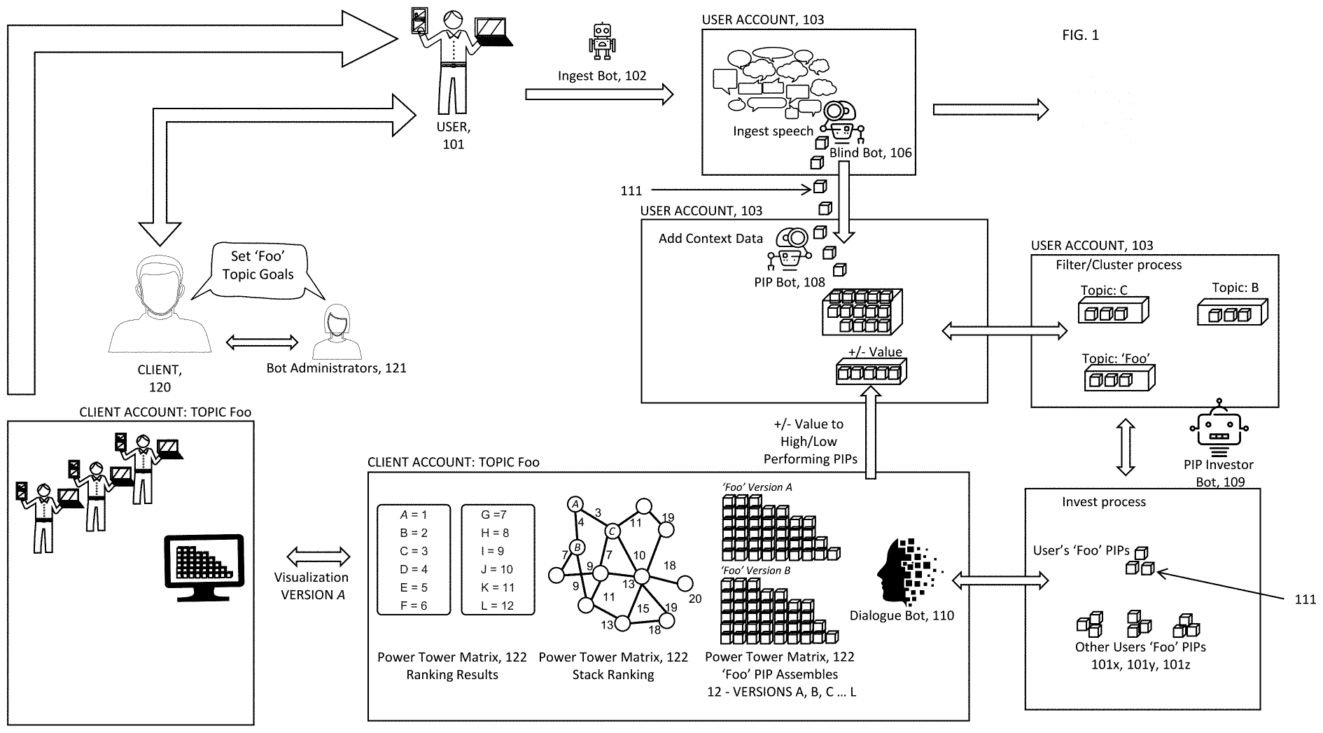

FIG. 2 shows an example of a visualization that may be employed by the System for Processing Continuous Feedback.

FIG. 3 shows a table used by the system to make certain decisions.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limits include both numbers. For example, “25 to 100” means a range whose lower limit is 25 and upper limit is 100 and includes both 25 and 100.

The system may begin with a User, 101, shown at the top. Through a computer or mobile device, a User may interact with an Ingest Bot, 102, to submit their feedback, comments, feelings, or other insight. The Ingest Bot, 102, may accept input in the form of human speech, reference URLs, video, voice analysis data, or location data which may enhance the intended meaning of the User, 101. To facilitate greater trust of its participants, the system may take all initial input and process it into anonymized artifacts called PIPs, 111, that the system may use to potentially influence a topic or dialogue that the User, 101, may show interest in.

Speech data may be submitted to a Blind Bot, 106, without the User's identity included while all other user specific data may be submitted to a PIP Bot, 108. After the input is processed by the Blind Bot, 106, and Ingest Bot, 102, the User's original input may be deleted. Before deletion of original text, Blind Bot, 106, may process data it receives from Ingest Bot, 102, while PIP Bot, 108, may wait for output from Blind Bot.

Blind Bot, 106, may first use each snippet of submitted text to create an array of guesses as to its possible meaning. Each guess is called an Outcome of Multiple Meaning (OMM). Each OMM is a different individual guess by Blind Bot, 106, as to what the speaker:
a. Wants to happen in the future
b. Defines/describes a person, place or thing
c. Defines/describes a concept
d. Agrees with or lends support to
e. Ranks in importance in relation to other persons, places, things or concepts
f. AI Progress Statement: This represents a statement regarding the system's interpretation of previous input. It is not a guess as to what the speaker means in the sense of the previous items on this list, however it is included as an outcome by Blind Bot in each OMM.

Example 1, if the speaker said, “I hate tomatoes.” The array might look like:
OMM: User hopes for a future with fewer tomatoes.
OMM: Tomatoes are a bad tasting food
OMM: Food preference is a thing people can be quite passionate about.
OMM: Not Tomatoes
OMM: For a list of top foods in the world tomatoes would not be at the top
AI Progress Statement: N/A

Example 2, if the speaker said, “The new re-org won't work for my X team because the engineers won't follow the proper procedures without our direct control of their performance reviews.” The array might look like:
OMM: Engineering Managers will need to pay more attention to Team X's procedures.
OMM: Engineers care about their performance reviews.
OMM: Commitments procedures mean nothing without executional excellence
OMM: Team X needs to be successful
AI Progress Statement: N/A

Example 3, if the speaker said, “X is a bad person and I hate them.” And ‘X’ was NOT a public figure then the array might look like:
OMM: there may be greater personal conflicts in this [topic/group] in the future
OMM: Is team X getting along?
OMM: Anger does not contribute to productive dialogue
AI Progress Statement: N/A

Example 4, if the speaker said, “X is a bad person and I hate them.” And ‘X’ was a public figure then the array might look like:
OMM: X is becoming less popular
OMM: X's detractors say . . . [align to a more productive critic]
OMM: X's position on the [Topic] isn't fully appreciated by those who support [align to higher scoring (i.e. more productive) opposition topic]
AI Progress Statement: N/A

The User's anonymized input may be stored in a User's User Account, 103, as a Potential Insight Packet, (“PIP”), 111. These PIPs, 111, may then be refined by PIP Bot, 108. A PIP is an anonymized artifact or data-object that raw speech text becomes so that it can contribute to a meaningful dialogue without causing backlash or repercussion for the User. It is made up of the following components:
a. An array of possible Outcomes of Multiple Meanings (OMMs) that Blind Bot, 106, guesses the speaker could have meant when they said what they said.
b. Context Variables that track the Context of the PIP such as
   i. Current PIP Value,
   ii. Current best OMM for the PIP,
   iii. When it was created,
   iv. Who it belongs to,
   v. What topic(s) it seems best suited to,
   vi. The owners (User, 101, and Client, 120) current Trust ID (TID) value at the time the PIP was created,
   vii. Ingest Bot's guess as to its value,
   viii. Blind Bot's guess as to its value,
   ix. If a Client's, 120, legal rights are involved with this PIP,
   x. Location,
   xi. Haptics, Voice analysis data,
   xii. Past performance of this PIP,
   xiii. If the user has looked at the PIP,
   xiv. If the user created child PIPs in reaction to this PIP,
   xv. List of those Child PIPs,
   xvi. If those Child PIPs changed the meaning of this PIP,
   xvii. (If applicable) Parent PIP,
   xviii. If the PIP is currently being used by Investor Bot, 109
   xix. If the PIP is currently being used by Dialogue Bot, 110
   xx. # of times invested and then used in the past,

So far, a PIP, 111, has been produced and refined in three stages, using an Ingest Bot, 102, a Blind Bot, 106, and a PIP Bot, 108:
1. The Ingest Bot, 102, knows who the user really is and captures raw speech text. It may have the ability to:
   a. Parse speech into potentially recognizable bits called snippets. For example, it can take 5 minutes of speech text and parse it into many (10-30, for example) different sized snippets many of which overlap with one another in terms of the original text.
   b. As it produces snippets it may also assign quality scores to each one trying to predict the future value of the PIP that gets created based upon that snippet.
   c. Tell the PIP Bot, 108, to expect incoming snippets for this user soon so PIP Bot can validate delivery.
   d. Receive a confirmation from PIP Bot, 108, when it has all the snippets from Blind Bot, 106, for this User and then delete the original raw speech audio and text.
   e. Later it receives updates from PIP Bot, 108, about the accuracy of its snippet guesses with which Ingest Bot, 102, updates its snipping learning model.
2. Blind Bot, 106, does not know who the User really is and receives snippets from Ingest Bot, 102, to produce the array of guesses as to what they mean (OMMs).
   a. Blind Bot may be one or more commercially available AI software packages used to handle speech recognition.
   b. As Blind Bot produces the array of possible meanings from a snippet it also assigns quality scores to each one trying to predict the future value of the PIP that gets created based upon each possible meaning in the array.
   c. Later Blind Bot receives updates from PIP Bot, 108, about the eventual accuracy of its guesses, updating the learning model.
   d. Blind Bot confirms deletion of every snippet it receives with Ingest Bot.
3. PIP Bot's, 108, function is to refine the OMNI array it may receive from Blind Bot, 106, based upon what we know about the User, 101. PIP Bot knows who the User is but may never see the original speech text. PIP Bot's functions may be to:
   a. Assign all appropriate Context Variables to the PIP
   b. As it assigns the contextual values, PIP Bot guesses the Topic(s), Value, and stack ranks the OMMs (snippets).
   c. Confirm delivery of a PIP from Blind Bot, 106 and Ingest Bot, 102.
   d. Confirm when a PIP has been picked up by the next bot, Investor Bot, 109, described later.
   e. Confirm when a PIP is being used by another bot, Dialogue Bot, 110, described later.
   f. Receive performance feedback from Dialogue Bot and Investor Bot, per topic and updates each PIP with the new Variables.

The data may then be queried and transmitted—from the User's Account, 103, to the PIP Investor Bot, 109. PIP Investor Bot does not know a User's real identity it but can look at PIP's, 111, across all User Accounts to collect PIP data into a Topics for Dialogue Bot, 110. PIP Investor Bot, 109, may use performance history of past submissions to the Dialogue Bot, 110, to determine whether a given collection of PIP's, 111, is likely to produce a good result. PIP Investor Bot, 109, defines when a collection of PIP's, 111, is coherent enough to submit to the Dialogue Bot, 110. To do this, PIP Investor Bot, 109, may:
1. maintain the existing ‘active topic’ topic hierarchy.
2. manage payment processes. For example: a User, 101, can look at all the PIP's in their User Account, 103, and the User would know that he or she has many PIP's that have contributed to the Topic of Too′ which is being sponsored by a Client, 120, but he or she cannot determine the total relative value of his or her PIP's in relation to other users, 101x, 101y, 101z. Only Investor Bot can determine a hierarchy of the Too′ contributors even though it cannot know their true identities. In some cases, a Client, 120, may offer a cash reward to the Users if the Topic accomplishes certain desired outcomes. Investor Bot must act as the go-between to ensure the money goes from the company to the correct User Accounts in proportion to their relative contribution.
3. ensure PIP's licensing. For example, if a PIP comes from User X who works for a Client and that company has sponsored an internal employee dialogue on Too′ then a PIP from that user must include evidence (as defined by the EULA with the Client) that it is not a Client-owned PIP. Conversely, PIP Investor Bot also protects the User's personal PIP's from being used by the company.
   Example 2: A Client is a Fortune 1000 company with 45,000 employees. Susan is one of those employees, and she is also an avid bridge player. The Client sponsors a 1-year conversation with its 45,000 employees about ‘Alignment to the Company's core Strategic Pillars.’ The game of bridge has enough passionate people using this system that it has its own topic called ‘The Evolution of Bidding in Bridge.’ Susan is an exemplary contributor to both conversations. Investor Bot is responsible for knowing which PIP's belong to the Fortune 1000 company and which belong to the bridge playing community. Along the way both the Client's topic and the bridge playing community's topic are successful. Investor Bot reports that it has 10,000's of PIP's that it suggests be invested into new Topics. Due to the tagging of PIP's done by Investor Bot, the system can know who to charge for each new topic. Additionally, Susan's identity stored separately in her User Account is safe if the decisions of Investor Bot need to be audited, and The Fortune 1000 company is safe even if Susan leaves the company that its proprietary data is not leaving with her.

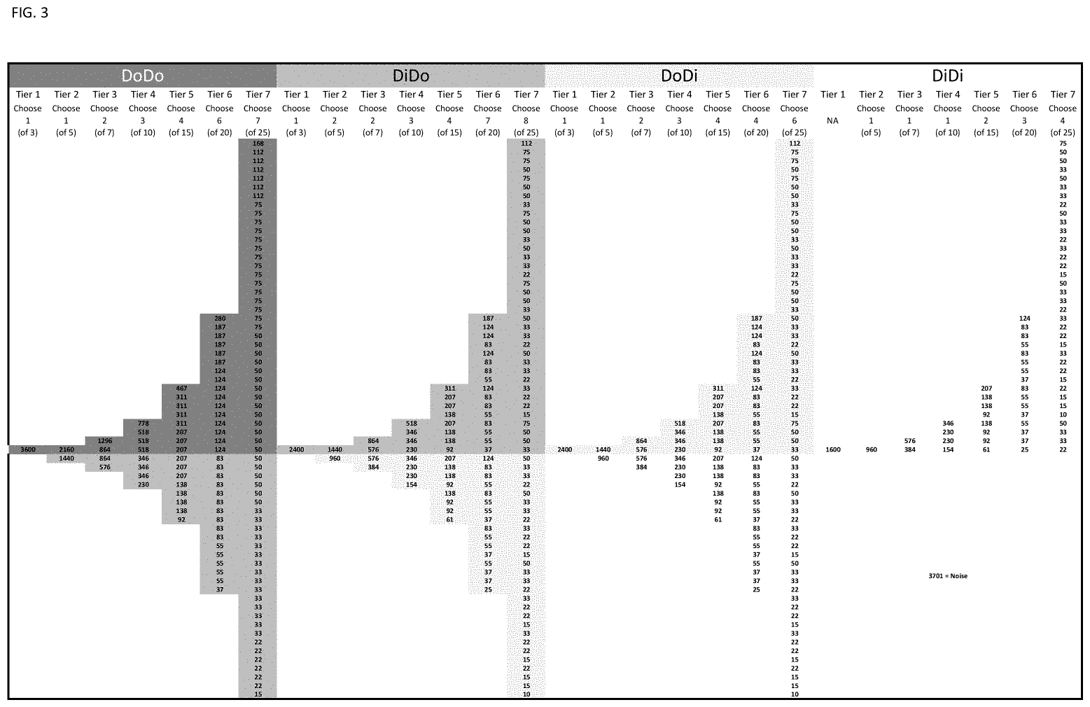

The data (the collection of PIP's, 111, assigned to a Topic) may then be transferred to a Dialogue Bot, 110. Dialogue Bot does not know the User's identity but does know groups of Users by topic. Dialogue Bot may then:
1. Take a Topic's PIPs, 111, and rearranges/prioritizes their OMMs into the ‘Power Tower Matrix’, 122, as follows:
   a. A listing (60% of the material) of OMMs that appear to be the Dominant paradigm (DoDo) for the Topic. (see FIG. 3 Table)
      i. A sub-listing of OMMs that appear to be the more Diverse perspectives within the Dominant group (DoDi) (see FIG. 3 Table)
   b. A listing (40% of the material) of OMMs that appear to be the Diverse perspectives for the Topic (DiDo) (see FIG. 3 Table)
      ii. A sub-listing of OMMs that appear to be the more Diverse perspectives within the Diverse group (DiDi) (see FIG. 3 Table)
   c. This pattern of lists may be iterated upon into deeper and deeper sub-groupings each split 60/40 between Dominant and Diverse perspectives until the data gets too thin for Dialogue Bot to determine that something is dominant anymore (see FIG. 3). The table shown on FIG. 3 represents the state of the matrix just before Dialogue Bot makes its 10 guesses (per tier) of which OMMs to reveal to the users to better generate productive feedback from them. Cells in the table are a simple representation of the result of multiple 60/40 splits of the OMMs in the matrix. (based upon a starting set of 10000 OMMs.
2. For each group in the ‘Power Tower Matrix’, 122, Dialogue Bot may rank the OMMs within it as follows:
   a. Dialogue Bot may compute a distance metric for all the OMMs in the Matrix. Where ‘distance’ is the sum of the context variables associated with every OMNI. This allows Dialogue Bot to rank potentially high value OMMs over less trusted sources. It also allows Dialogue Bot to recognize new speakers who are potentially high value but not yet recognized by the system. Conversely it this ‘distance’ ranking also diminishes the impact that less trusted or less productive voices might have on the discussion.
      A. Example: +1 for every OMNI whose user ID is more trusted than the “outcome-focused” meaning above it in the list
      B. Example: +5 for every OMNI who's user ‘past productive dialogue’ score is higher “outcome-focused” meaning above it in the list
      C. Example: −5 for every OMNI that comes from a user who is new to this topic
3. Given the current Power Tower Matrix, 122, Dialogue Bot, 110, makes a guess as to:
   a. Tier one (the top 3 choices)
      ii. An array of the most similar two OMMs between the Dominant/Diverse and the Diverse/Dominant lists (10 guesses)
      iii. An array of the most similar Pure Dominant OMM that relates to the previous two (10 guesses)
   b. Tier two (the subsequent 5 choices)
      i. An array of the most similar two OMMs between the Dominant/Diverse and the Diverse/Dominant lists that are not in Tier 1 (10 guesses)
      ii. An array of the most similar two Pure Dominant OMM that relates to the previous two (10 guesses)
      iii. An array of the most Diverse/Dominant OMM that does not appear to have a matching OMM from the Dominant/Diverse side.
   c. Tier 3 (the subsequent 7 choices)
   d. Tier 4 (the subsequent 10 choices)
   e. Tier 5 (the subsequent 15 choices)
   f. Tier 6 (the subsequent 20 choices)
   g. Exhibit A shows full the process of computing these rankings.
4. The Tier process stops when Dialogue Bot, 110, runs out of OMMs that it can successfully differentiate with its distance metric. The rest are considered the ‘long tail’ of Diversity/Diversity (“DiDi”) which is often indistinguishable from “Noise.”
5. Next, for each guessed version of each tier, Dialogue Bot calculates a Time Period Score, Popularity Score, Quantity Score, Quality Score and Productive Score.
   a. Quantity Score predicts if the volume (determined by server logs of number of users seeing Dialogue Bot's output and subsequent volumes of speech coming into this topic over time) will go up or down. It calculates this by comparing the array of the distance scores from previously published versions and subsequent activity in the server logs.
   b. Popularity Score predicts # of new users (their PIPs) will provide new speech to this Topic in the next cycle. It calculates this by comparing the array of the distance scores of previous ‘new speakers’ from previous published versions with the number of net new speakers the server logs recorded joining the Topic.
   c. Quality Score predicts if the quality (cumulative scores given to speech, OMMs and PIPs by the other Bots) of the speech coming into the topic will go up or down. It calculates this by looking at the rate of change that resulted from previous published versions and their similarity or lack thereof with this new version.
   d. Productivity Score predicts the likelihood that the meanings of the OMMs will “advance” in the next cycle of input vs. remaining “static” with current values. It calculates this by looking at the trend line for previous Quantity, Popularity and Quality Scores against targets set by the Client, 120, and the Bot Administrators, 121.

Example of How Representitive OMMs are Selected by
Dialogue Bot to Maintain 60/40 Representation
Domanant/Domanant = DoDo | Domanant/Diverse = DoDi |
Diverse/Domanant = DiDo | Diverse/Diverse = DiDi

| Numbers that divide into round intigers 60/40 from smallest up | DoDo | DoDi | DiDo | DiDi |
|---|---|---|---|---|
| Tier 1 (3) | 1 | 1 | 1 | 0 |
| Tier 2 (5) | 1 | 2 | 1 | 1 |
| Tier 3 (7) | 2 | 2 | 2 | 1 |
| Tier 4 (10) | 3 | 3 | 3 | 1 |
| Tier 5 (15) | 4 | 4 | 4 | 2 |
| Tier 6 (20) | 6 | 7 | 4 | 3 |
| Tier 7 (25) | 7 | 8 | 6 | 4 |
| Tier 8 (30) | 9 | 9 | 7 | 5 |
| Tier 9 (35) | 11 | 10 | 8 | 6 |

(Note 3 and 7 don't divide evenly but balance each other out)

e. Time Period is how long Dialogue Bot will wait for input to stream in before producing the next version. It calculates this based upon previous bell curves of time over new input captured and then adds or subtracts a set increment of time from its last value against targets set by the Client, 120 and the Bot Administrators, 121.
f. Dialogue Bot chooses the version with the highest Productivity Score that does not create more than a certain percentage of potential ‘noise’ against targets set by the Client, 120 and the Bot Administrators, 121, in the other three scores.
6. Generates one page in the computer or mobile software per active topic with the following:
   i. A visual representation of the Ranked Power Tower Matrix that Dialogue Bot picked that users can:
      i. “Surf” thru tier by tier and OMM by OMNI.
      ii. See how Dialogue Bot predicts the next version will look.
      iii. See how Dialogue Bot asks for help explaining something it does not ‘understand’
      iv. See how Dialogue Bot shows what happened to concepts that were in the top tiers in the last iteration and were reacted to by users.
      v. See where in the Tower a user's invested PIPs had some sort of impact.
      vi. Record new speech that goes to Ingest Bot with the correct topic, tier and (if applicable) OMMs already embedded in the values.
7. Based upon the final version Dialogue Bot then:
   a. Updates PIP values back to PIP Bot
   b. Updates Topic definition values back to Investor Bot
   c. Begins sorting OMMs for the next iteration.

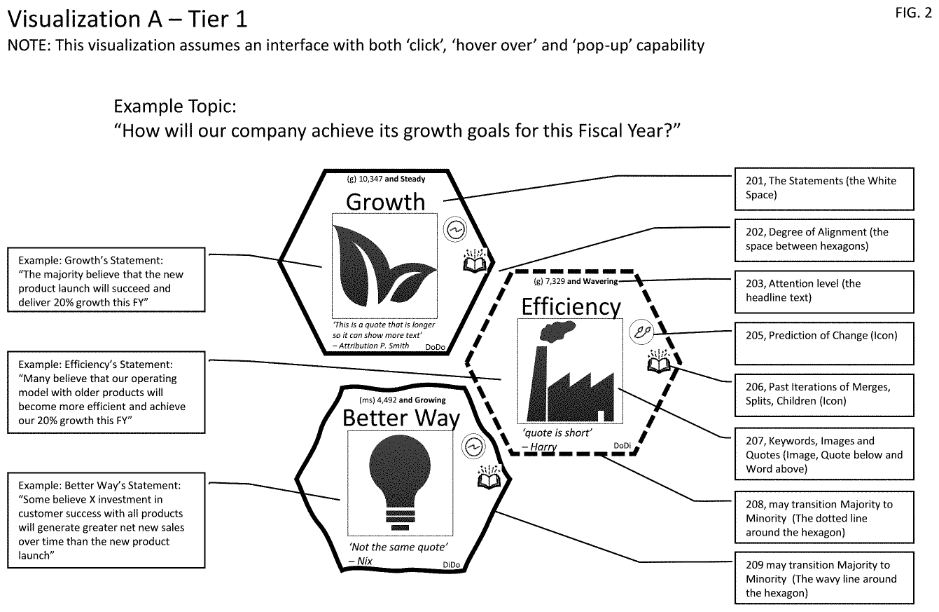

After processing by the bots is completed, a visualization of the feedback may be presented to the Client, 120. In the visualization description below, visual assets such as keywords, images, public quotes, icons, and effects are intentionally referred to in generic terms. The Visualization may be made up of:
i. Raw Assets—the statements, and their meta data and any publishable data (i.e. properly anonymous that cannot be reverse engineered) generated by Dialogue Bot
ii. Representational Assets—public images, quotes, icons that are associated with the statement. These items may allow the User to find the system more personable or relatable.
iii. Encouragement Effects—effects that draw the participant's attention to where the dialogue needs their attention the most
   A sample Visualization A, shown on FIG. 2, may have the following characteristics.

### Growth, 201:

The Statements: For any white space in a hexagon, a mouse hover over shows a statement text. A User may interact with the Visualization in order to submit additional input. If the User clicks on a hexagon's white space, it may speak to the system to submit additional input, which may then be processed by Ingest Bot, 102, and proceed through the rest of the system. They system may acknowledge that the User's input is of relevance to the associated hexagon.

### 202, Degree of Alignment (for Each Additional Pixel Between Hexagons Means Less Aligned):

A mouse hover over shows exact values. A User may click in the space between hexagons to comment on the Degree of Alignment. This additional input may then be processed by Ingest Bot, 102, and proceed through the rest of the system.

### 203, Attention Level

A mouse hover over shows where in the Power Tower Matrix, 122, this statement originates. A User may click here to comment on the Attention Level.

### 205, Prediction of Change Icon

EXAMPLE: predicting that this statement may split apart

A mouse hover over shows likelihood of change as a percentage. A User may click here to comment on this item.

206, Past Iterations of this Statement (Merges, Splits, Children)

A User may click to open a pop-up of family tree of current statements ‘related’ to this one in other tiers.

### 207, Keywords, Images and Quotes

A mouse hover over shows current alignment score. A User may click to open a pop-up to ‘vote for’ alternates & targets input.

208, this Statement May Transition (Majority to Minority)

A mouse hover over the border of the statement (dotted line) shows that if this concept splits then the resulting pieces may not be in the dominant group anymore. A User may click here to comment on this item.

209, This Statement may transition (Minority to Majority)

A mouse hover over the border of the statement (wavy line) shows that this concept likely to merge after major changes to the statement. A User may click here to comment on this item.

The invention claimed is:

1. A system, using a computer, that enables a conversation amongst a population, comprising;
the ability to conceal the identity of individuals in said population;
an algorithm which processes said population's raw input for possible meanings;
a display of which said meanings said system determines as said population's highest priorities;
the ability to reprocess said meanings with additional input from said population.

2. The system of claim 1, further comprising the ability to detect and prevent bots from interfering with said system.
